(19) United States
(12) Patent Application Publication
(10) Pub. No.: US 2007/0261045 A1
(43) Pub. Date: Nov. 8, 2007

(54) METHOD AND SYSTEM OF CONFIGURING A DIRECTORY SERVICE FOR INSTALLING SOFTWARE APPLICATIONS

(75) Inventors: Manoj Sharad Gujarathi, Round Rock, TX (US); Charles T. Perusse JR., Pflugerville, TX (US); Drue Reeves, Round Rock, TX (US); Ahmad H. Tawil, Round Rock, TX (US)

Correspondence Address: BAKER BOTTS, LLP, 910 LOUISIANA, HOUSTON, TX, 77002-4995, US

(73) Assignee: DELL PRODUCTS L.P., Round Rock, TX (US)

(21) Appl. No.: 11/381,935

(22) Filed: May 5, 2006

(51) Int. Cl. G06F 9/44

(52) U.S. Cl. 717/168

(57) ABSTRACT

An improved system and method for providing updates, drivers and other utilities to target systems utilizes a directory service. A target object, a policy object and a virtual media image object are provided within the directory service. The virtual media image object includes one or more updates needed by the associated target system. The target system may automatically access the directory service and interface with the target object and policy object to locate the virtual media image object and gain access to the virtual media image object.

### TECHNICAL FIELD

The present invention is related to the field of computer systems and more specifically to a system and method of configuring a directory service to install software applications on associated target systems.

### BACKGROUND OF THE INVENTION

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

In order for an information handling system such as a server to operate as desired and to be able to efficiently communicate with other devices and peripheral components, appropriate software applications and utilities, such as drivers, must be installed on the information handling system. After initial configuration of an information handling system, the required set of drivers may be amended. Additionally, updates for certain applications often become available after initial installation and configuration.

Maintaining an operating system with an up to date set of system specific drivers represents a significant challenge. Establishing which applications need to be updated and properly installing such updates often requires assistance from skilled information technology personnel. Determining and installing updates represents one of the top call drivers for help desks and technical support resources. Due to the challenges to properly updating applications, many applications are not updated in a timely fashion, thereby impairing the overall efficacy of the system.

### SUMMARY OF THE INVENTION

Therefore a need has arisen for a system and method for automatically updating applications in a target system utilizing a centralized repository.

A further need has arisen for a system and method for providing updates and drivers to a target system utilizing a directory service.

The present disclosure includes an improved system and method for providing updates, drivers and other utilities to target systems using a directory service. Within a directory service, a target object, a policy object and a virtual media image object where the virtual media image object includes one or more updates needed by the associated target system. The target system may automatically access the directory service and interface with the target object and policy object to locate the virtual media image object and gain access to the virtual media image object.

In one aspect, an information handling system is disclosed that includes a target system in communication with a directory service. The target system includes an update module and the directory service includes a target object, a policy object, and a virtual media image object. The target object is configured to identify the policy object and the policy object is configured to identify the virtual media image object. The virtual media image object includes an application for installation on the target system and the update module is configured to communicate with the directory service and interface with the target object, the policy object and the virtual media object to access the application.

In another aspect, a directory service for providing virtual media image objects associated target systems includes multiple virtual media image objects and multiple policy objects. Each policy object is configured to identify at least one virtual media image object. The directory service also includes a target object configured to communicate with an associated target system to identify at least one policy object and at least one virtual media image object.

In yet another aspect, a method for accessing a virtual media image object includes extending a target object schema within a directory service to a virtual media auxiliary class. The method also includes creating a virtual media image object within the directory service and building a relationship between the target object, a policy object within the directory service and the virtual media image object. Next, the method includes configuring a target server to automatically communicate with the target object and the policy object to access the virtual media image object.

The present disclosure includes a number of important technical advantages. One important technical advantage is the use of a target object, a policy object and a virtual media image object within a directory service to provide access to the virtual media image object to associated target systems. This allows updates and drivers to be made available in a centralized repository and allows for the automated dissemination of updates and drivers. Additional advantages will be apparent to those of skill in the art from the figures description claims provided herein.

### BRIEF DESCRIPTION OF THE DRAWINGS

A more complete and thorough understanding of the present embodiments and advantages thereof may be acquired by referring to the following description taken in conjunction with the accompanying drawings, in which like reference numbers indicate like features, and wherein:

FIG. 1 shows a diagram of an information handling system employing a directory service in accordance with the teachings of the present disclosure;

FIG. 2 shows a diagram of another embodiment of an information handling system with a directory service configure according to teachings of the present disclosure; and

FIG. 3 shows a flow diagram showing a method according to teachings of the present disclosure.

### DETAILED DESCRIPTION OF THE INVENTION

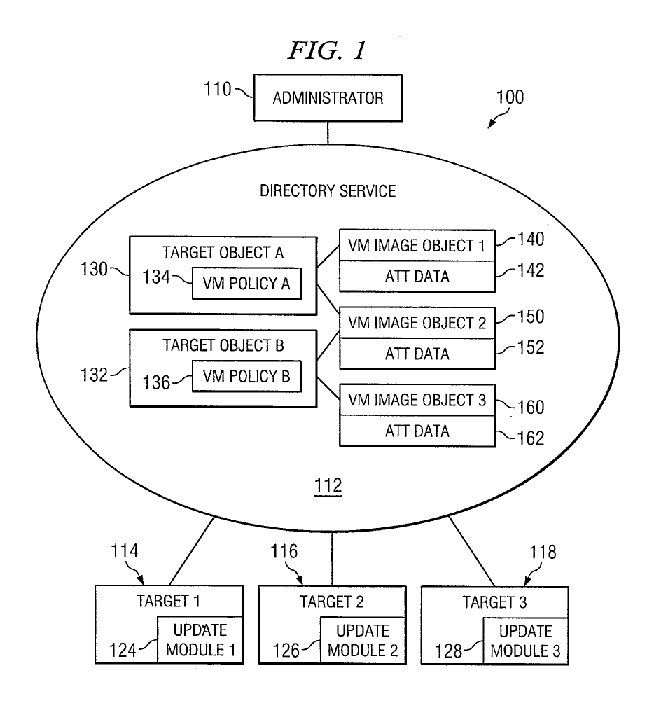

Preferred embodiments of the invention and its advantages are best understood by reference to FIGS. 1-3 wherein like numbers refer to like and corresponding parts and like element names to like and corresponding elements.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

Now referring to FIG. 1, an information handling system, indicated generally at 100, is shown. Information handling system 100 generally includes administrative server 110 in communication with directory service 112 via a network connection or other suitable connection. Directory service 112 is further in communicating with first target system 114, second target system 116 and third target system 118. Target system 114, 116 and 118 may be any suitable system or information handling system component operable to communicate and interface with directory service 112. Target systems 114, 116 and 118 may also be referred to as target servers, client servers or client systems. Each target system is communicatively coupled with directory service 112 by a network or other suitable connection. In the present embodiment, directory service 112 is shown in communication with three target systems. In alternate embodiments, more or fewer target systems may be in communication with directory service 112.

Directory service 112 includes target object A 130 and target object B 132. Target objects 130 and 132 may be referred to as a “server object,” a “client object,” or the like and may comprise any suitable object for representing an information handling system component. Target object A 130 includes virtual media policy object A 134 which may also be referred to as VM policy object or simply as a policy object. Target object B 132 includes virtual media policy object B 136 which may also be referred to as VM policy object or simply as a policy object. Target Object A 130 and VM policy object A 134 are preferably configured to be associated with each other and target object B 132 and VM policy object B 136 are preferably configured to be associated with each other. The configuration of the relationship between target objects 130 and 132 with policy objects 134 and 136, respectively, may be carried out by an administrator or other appropriate user at administrative server 110.

VM policy object A 134 is associated with first virtual media image object 140 and second virtual media image object 150. VM policy object B 136 is associated with second virtual media image object 150 and third virtual media image object 160. Each of VM policy objects 140, 150 and 160 includes a respective attribute data field 142, 152 and 162. Data field 142, 152 and 162 may include, for example, the type media, capacity attribute or other suitable information. Each virtual media image object 140, 150 and 160 includes at least one image of a software application. Virtual media images may comprise an image of an update for a particular software application, a patch, a driver, or any other utility, application or portion of code that may need to be distributed to target servers 114, 116 and 118 and may generally be referred to herein as an “update”. Virtual media image object 140, 150 and 160 may include the image of the desired update (and may be referred to as a “container object”) or may include a pointer to a storage resource within or in communication with directory service 112 (and may be referred to as a “leaf object”).

The present embodiment depicts two target objects 130 and 132 associated with systems in directory service, two virtual media policy objects 134 and 136 and three virtual media image objects 140, 150 and 160. In alternate embodiments directory service may comprise more or fewer target objects, policy objects and virtual media images objects that may be configured in any suitable manner. For example, multiple virtual media image objects may be associated with virtual media policy object 134 and multiple policy objects may be associated with target object 130.

First target server 114 includes update module 124. Second target server 116 includes update module 126. Third target server 118 includes update module 128. Each update module 124, 126 and 128 represents any suitable hardware or software, including controlling logic, that carries out the functions described herein. Update modules 124, 126 and 128 are configured to communicate with directory service 112. Update modules 124, 126 and 128 are each preferably configured to interface with target object 130 and/or 132. For example, target object 130 may provide update module 124 with a distinguished named pointer identifying policy object 134. Following, for example, communicating with target object 130, first update module 124 may be directed to policy object 134. First update module 124 may then gain access to first virtual media image object 140 and/or second virtual media image object 150. First update module 114 is preferably configured to initiate a virtual media session or other suitable communication with a virtual media image object to load the update application stored thereon and install the update within target system 114.

In an example operation, second update module 126 of second target system 116 may contact directory service 112 and provide appropriate authentication information such as, for example, a user name and password. This action may take place during a boot operation of second target system 116. Second update module 126 may then discover target object 132. Target object 132 may subsequently identify policy object 136. Policy object 136 may then identify virtual media image objects 150 and 160. In one embodiment policy object 136 may use distinguished named pointers to identify virtual media image objects 150 and 160. Update module 126 may then access attribute information 152 and 162 and determine whether either or both of virtual media image objects 150 and 160 should be installed on associated target system 116.

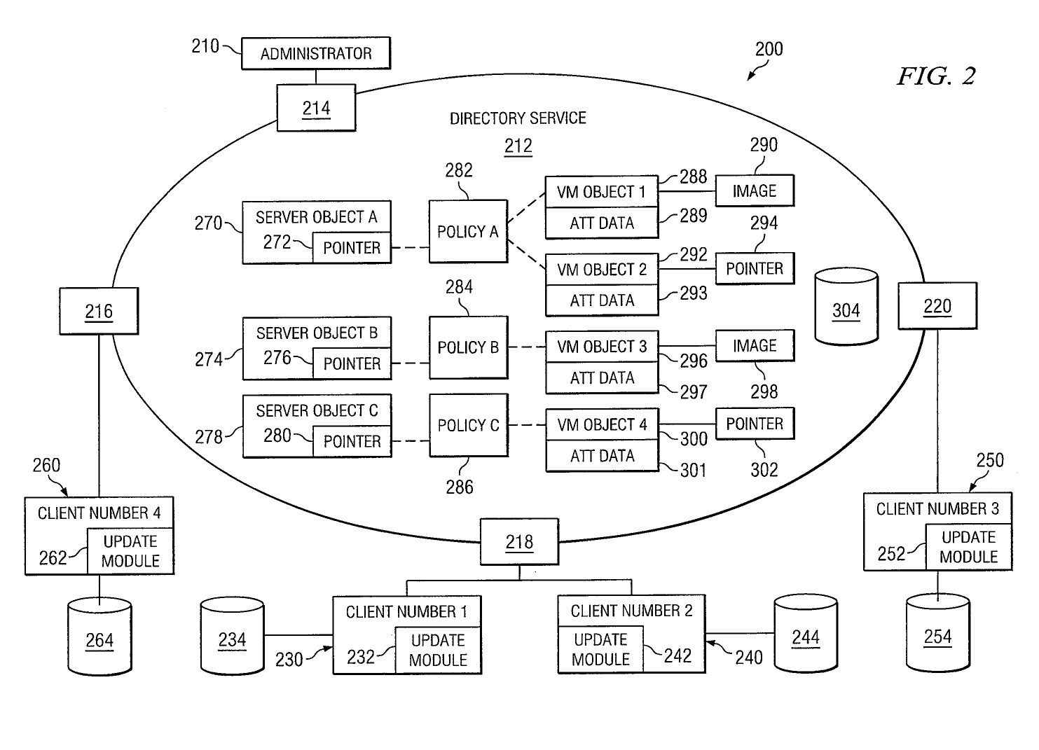

Now referring to FIG. 2, an information handling system, generally depicted at 200, is shown. Information handling system 200 generally includes an administrative node 210 in communication with directory service 212. Administrative node 210 is in communication with directory service 212 through a network or other suitable connection. Administrative node 210 preferably allows a user with administrative rights to manage directory service 212 and the objects stored therein. Administrative node 210 may also manage client systems 230, 240, 250, and 260 and their respective update modules 232, 242, 252 and 262 as discussed below. In the present embodiment directory service includes servers 214, 216, 218 and 220 that may be in communication with one another and may all contain and update directory service object information according to directory service protocols well know to those of ordinary skill in the art. In the present embodiment, servers 214, 216, 218 and 220 may be remotely located with respect to one another.

Target or “client” systems 230, 240, 250 and 260 are in communication with directory service 212 via a communication network or any other suitable connection. Client systems 230, 240, 250 and 260 may comprise servers or other suitable information handling system components. Each client system includes a corresponding update module 232, 242, 252 and 262. Each client system 230, 240, 250 and 260 also includes a local storage resource 234, 244, 254 and 264 respectively. Local storage 234, 244, 254 or 264 may be integrated within the respected client system or external to each client system. Local storage 234, 244, 254 and 264 may comprise a hard drive or any other suitable storage resource.

Directory service 212 includes target objects 270, 274 and 278 which may also be referred to as server objects. Each target object 270, 274 and 278 includes a respective pointer 272, 276 and 280. Each pointer 272, 276 and 280 identifies an associated policy object such as policy A 282, policy B 284 and policy C 286. In one embodiment, pointers 272, 276 and 280 may comprise a distinguished named pointer. Policy object A 282 is associated with virtual media image objects 288 and 292. Policy object B 284 is associated with virtual media image object 296. Policy object C is associated with virtual media image object 300.

Each virtual media image object 288, 292, 296 and 300 includes corresponding attribute data 289, 293, 297 and 301. In the present embodiments, virtual media image objects 288 and 296 are so-called container objects and are linked with images 290 and 298, respectively, that contain one or more selected updates, drivers or other software applications. Virtual media image objects 292 and 300 are so-called leaf objects and are linked to pointer 294 and 302. Pointers 294 and 302 contain information regarding the location of a desired update, which may be located on a data storage outside of directory service 212 such as on one of storage resources 234, 244, 254 and 264.

In operation, an administrator using administrative node 210 may configure the relationships between server objects 270, 274, 278, policy objects 282, 284, 286 and virtual media image objects 288, 292, 296 and 300. Administrative node 210 may be used to create virtual media images 290 and 300. Administrative node 210 may also be used to configure update modules 232, 242, 252 and 262. Similar to the update modules of FIG. 1, update modules 232, 242, 252 and 262 communicate with directory service 212 to access one or more of server objects 270, 274 and 278. Subsequently, the update module preferably accesses an associated policy object 282, 286 or 290 and identifies a virtual media image object 288, 292, 296 and 300.

Policy objects 288, 292, 296 and 300 (as well as policy objects 134 and 136 discussed above) may comprise, for example, one or more distinguished named pointers to a virtual media object, a description of the policy and its properties, a version of the policy, a load order of virtual media images operable to define a sequence thereof, a list of dependencies, and any other suitable policy related information. Policy objects 288, 292, 296 and 300 may also define the types of images to be installed and/or define dependencies on other media policy objects. Based on attribute data 289, 293, 297 or 301 the update module then identifies any required updates for its associated client.

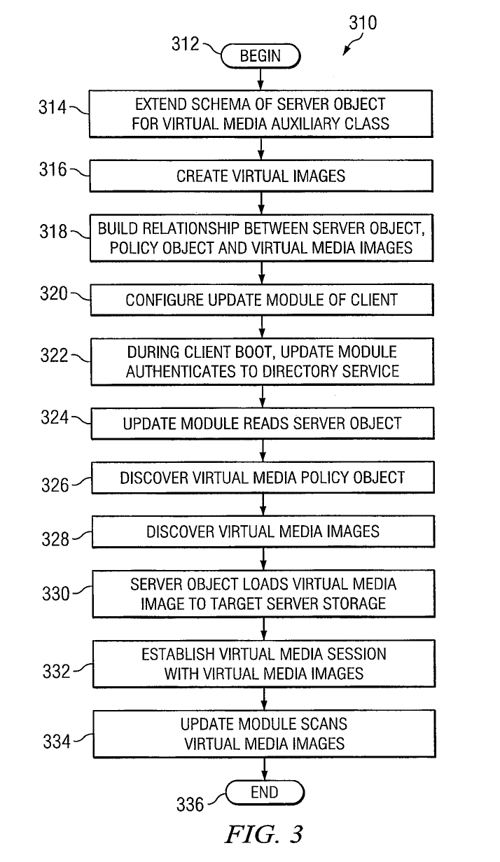

Now referring to FIG. 3, a method for accessing a virtual media image object, indicated generally at 310, is shown. The method begins at 312 by extending the schema of a target object for a virtual media auxiliary class 314. For example, while the directory service may have an existing server object with a corresponding schema, the schema of the server object may preferably be extended adding auxiliary class which may be referred to as a “virtual media auxiliary class”. Next, an virtual images of desired update applications are created 316 and stored in a directory service. An administrator may then preferably build relationships between the target object, policy objects within the directory service and the virtual media images 318.

An update module within an associated target server may then preferably be configured 320. The update module may preferably be configured to authenticate to the directory service during a boot operation of the target server 322. The update module may then read a selected server object 324 and utilize the resulting information to identify an associated virtual media policy object 326. Based on the information obtained from the policy object, update module may locate selected virtual media image objects 328 and load the virtual media image object or objects to a storage resource of target server 330. The policy object may use a distinguished named pointer to identify the appropriate virtual media image object. The storage resource may be a local storage device or may be virtual storage allotted to the target server within the directory service.

The update module may then establish a virtual media session with the virtual media image 332. The virtual media image may then be scanned by the update module 334 for installation onto the associated target system. In one embodiment, the virtual media image object may be presented to the operating system of the associated target system as a boot entry vector to inject into the operating system in a pre-operating system environment or following operating system installation.

Although the disclosed embodiments have been described in detail, it should be understood that various changes, substitutions and alterations can be made to the embodiments without departing from their spirit and scope.

What is claimed is:

1. An information handling system comprising:
at least one target system communicatively coupled with a directory service, said target system having an update module;
the directory service comprising a target object, a policy object, and a virtual media image object, the target object configured to selectively identify the policy object, the policy object configured to selectively identify the virtual media image object;
the virtual media image object comprising an application for installation on the at least one target system; and
the update module configured to communicate with the directory service and interface with the target object, the policy object and the virtual media object to access the application.

2. The information handling system of claim 1 further comprising a plurality of target systems communicatively coupled with the directory service, each target system comprising an update module.

3. The information handling system of claim 1 wherein the directory service comprises a plurality of target objects.

4. The information handling system of claim 1 wherein the directory service comprises a plurality of virtual media image objects corresponding to the policy object.

5. The information handling system of claim 1 wherein the virtual media image object comprises a leaf object.

6. The information handling system of claim 1 wherein the virtual media image object comprises a container object.

7. The information handling system of claim 1 wherein the virtual media image object comprises attribute data listing information associated with the virtual media image object.

8. The information handling system of claim 1 wherein the virtual media image object comprises an update for a software application.

9. The information handling system of claim 1 wherein the virtual media image object comprises a driver.

10. The information handling system of claim 1 wherein the target object is configured to provide a distinguished named pointer to the update module, the distinguished named pointer identifying the policy object.

11. The information handling system of claim 1 further comprising an administrative server in communication with the directory service, the administrative server operable to manage the relationships between the target object, the policy object and the virtual media image object.

12. A directory service for providing virtual media image objects to one or more associated target systems comprising:
a plurality of virtual media image objects;
a plurality of policy objects, each policy object configured to identify at least one virtual media image object; and
at least one target object, the target object configured to communicate with an associated target system to identify at least one policy object and at least one virtual media image object.

13. The directory service of claim 12 wherein the policy object is configured to identify two or more selected virtual media image objects in response to interfacing with the associated target system.

14. The directory service of claim 12 further comprising a plurality of target objects, each target object configured to communicate with an associated target system to identify at least one policy object and at least one virtual media image object.

15. The directory service of claim 12 wherein the at least one virtual media image object comprises an update for a software application.

16. The directory service of claim 12 wherein the at least one virtual media image object comprises a driver.

17. The directory service of claim 12 wherein the target object is configured to provide a distinguished named pointer to the associated target system, the distinguished named pointer identifying the policy object.

18. A method for accessing a virtual media image object comprising:
extending a target object schema within a directory service to a virtual media auxiliary class;
creating at least one virtual media image object within the directory service;
building a relationship between the target object, a policy object within the directory service and the at least one virtual media image object; and
configuring a target server to automatically communicate with the target object and the policy object to access the at least one virtual media image object.

19. The method according to claim 18 further comprising the target object automatically downloading the at least one virtual media image object.

20. The method according to claim 18 further comprising configuring an update module associated with the target object to automatically access the directory service to determine whether the virtual media image object contains at least one update application.
